(19) United States
(12) Patent Application Publication
(10) Pub. No.: US 2016/0223244 A1
(43) Pub. Date: Aug. 4, 2016

(54) LINER FOR A REFRIGERATOR APPLIANCE

(71) Applicant: General Electric Company, Schenectady, NY (US)

(72) Inventor: Keith Wesley Wait, Louisville, KY (US)

(21) Appl. No.: 14/608,237

(22) Filed: Jan. 29, 2015

(51) Int. Cl. F25D 17/04; B23P 15/26; F25D 17/06

(52) U.S. Cl. CPC F25D 17/045; F25D 17/06; F25D 17/067; B23P 15/26

(57) ABSTRACT

A refrigerator appliance including a sealed system for cooling air in a cabinet is provided. The cabinet includes a liner with a plurality of walls defining a chilled chamber. Within the plurality of walls, the liner defines an inlet, a plurality of airflow delivery conduits in flow communication with the inlet, and plurality of orifices connecting the plurality of airflow delivery conduits to the chilled chamber such that chilled air from the sealed system is distributed throughout the chilled chamber via the plurality of airflow delivery conduits.

### FIELD OF THE INVENTION

The present subject matter relates generally to appliances, such as refrigerator appliances, and liners for the same.

### BACKGROUND OF THE INVENTION

Certain refrigerator appliances utilize sealed systems for cooling chilled chambers of the refrigerator appliances. A typical sealed system includes an evaporator and a fan, the fan generating a flow of air across the evaporator and cooling the flow of air. The cooled air is then provided through an opening into the chilled chamber to maintain the chilled chamber at a desired temperature. Air from the chilled chamber is circulated back through a return duct to be re-cooled by the sealed system during operation of the refrigerator appliance, maintaining the chilled chamber at the desired temperature.

Under ideal conditions, the air circulation through the chilled chamber provides for a desired temperature uniformity throughout the chilled chamber. Frequently, however, food or other items to be refrigerated disrupt the air circulation through the chilled chamber, which can lead to undesirable temperature gradients in the chilled chamber. For example, food or other items to be refrigerated may be placed adjacent to the opening through which cooled air is provided, blocking or redirecting a flow of cooled air from the inlet.

Accordingly, a refrigerator appliance including one more features for ensuring a more uniform temperature throughout the chilled chamber would be useful. More particularly, a refrigerator appliance including one more features for ensuring a more uniform temperature throughout the chilled chamber despite the positioning of any food or other items to be refrigerated in the chilled chamber would be especially beneficial.

### BRIEF DESCRIPTION OF THE INVENTION

Aspects and advantages of the invention will be set forth in part in the following description, or may be apparent from the description, or may be learned through practice of the invention.

In a first exemplary embodiment, a refrigerator appliance is provided. The refrigerator appliance includes a sealed system for cooling air and a cabinet including a liner. The liner has a plurality of walls, the plurality of walls defining a chilled chamber. The liner defines an inlet for receiving chilled air from the sealed system and a plurality of airflow delivery conduits. The plurality of airflow delivery conduits are in flow communication with the inlet and extend through or adjacent to one or more of the plurality of walls. The liner also defines a plurality of orifices defined in one or more of the plurality of walls connecting the plurality of airflow delivery conduits to the chilled chamber such that chilled air from the sealed system is distributed throughout the chilled chamber through the plurality of airflow delivery conduits.

In an exemplary aspect, a method is provided for forming a liner for a refrigerator appliance. The method includes determining three-dimensional information of the liner and converting the determined three-dimensional information of the liner into a plurality of slices. Each slice of the plurality of slices defines a respective cross-sectional layer of the liner. The method also includes successively forming each cross-sectional layer of the liner with an additive process. After successively forming each cross-sectional layer of the liner with an additive process: (1) the liner includes a plurality of walls defining a chilled chamber; (2) the liner defines an inlet for receiving chilled air from a sealed system; (3) the liner further defines a plurality of airflow delivery conduits in flow communication with the inlet; and (4) the liner further defines a plurality of orifices connecting the plurality of airflow delivery conduits to the chilled chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance according to an exemplary embodiment of the present subject matter.

FIG. 2 provides a front, elevation view of the exemplary refrigerator appliance of FIG. 1. In FIG. 2, refrigerator doors of the exemplary refrigerator appliance are shown in an open position in order to reveal a fresh food chamber of the exemplary refrigerator appliance.

FIG. 3 provides a perspective view of a liner of the exemplary refrigerator appliance of FIGS. 1 and 2.

FIG. 4 provides a cross-sectional view of a plurality of airflow delivery conduits defined in the liner of the exemplary refrigerator appliance of FIGS. 1 and 2 taken along Line 4-4 in FIG. 3.

FIG. 5 provides a cross-sectional view of an airflow delivery conduit defined in the liner of the exemplary refrigerator appliance of FIGS. 1 and 2 taken along Line 5-5 in FIG. 3.

FIG. 6 provides a flow diagram of an exemplary method for forming a liner in accordance with an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

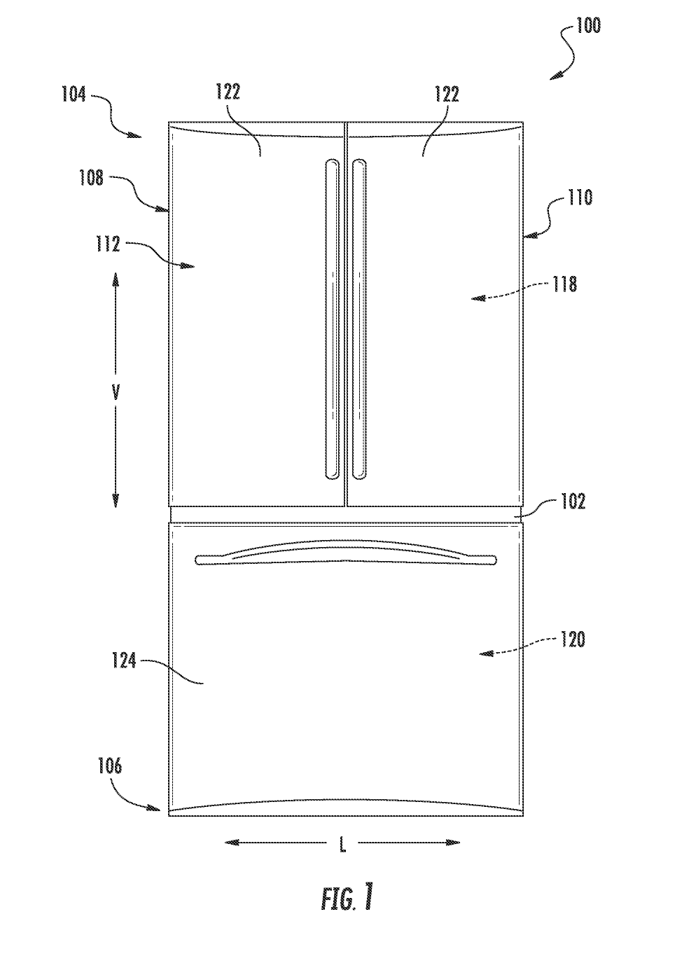

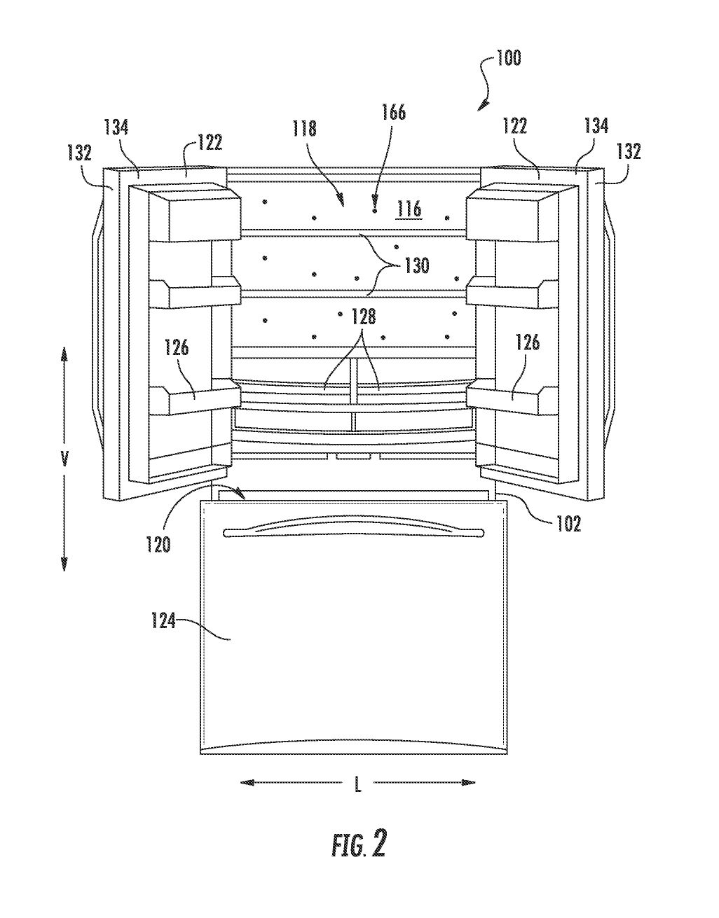

FIG. 1 provides a front, elevation view of a refrigerator appliance 100 according to an exemplary embodiment of the present subject matter with refrigerator doors 122 of the refrigerator appliance 100 shown in a closed position. FIG. 2 provides a front view of refrigerator appliance 100 with refrigerator doors 122 shown in an open position to reveal a fresh food chamber 118 of refrigerator appliance 100.

Refrigerator appliance 100 includes a cabinet or housing 102 that extends between a top 104 and a bottom 106 along a vertical direction V, between a first side 108 and a second side 110 along a lateral direction L, and between a front side 112 and a rear side 114 along a transverse direction T. Additionally, cabinet 102 includes a liner 116 (FIG. 2), and the liner 116 defines a chilled chamber for receipt of food items for storage. In particular, liner 116 defines two chilled chambers—a fresh food chamber 118 positioned at or adjacent top 104 of cabinet 102 and a freezer chamber 120 arranged at or adjacent bottom 106 of cabinet 102. As such, refrigerator appliance 100 is generally referred to as a bottom mount refrigerator. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Refrigerator doors 122 are rotatably hinged to an edge of cabinet 102 for selectively accessing fresh food chamber 118. In addition, a freezer door 124 is arranged below refrigerator doors 122 for selectively accessing freezer chamber 120. Freezer door 124 is coupled to a freezer drawer (not shown) slidably mounted within freezer chamber 120. As discussed above, refrigerator doors 122 and freezer door 124 are shown in the closed configuration in FIG. 1, and refrigerator doors 122 and freezer door 124 are shown in the open position in FIG. 2.

Referring now particularly to FIG. 2, various storage components are mounted within fresh food chamber 118 to facilitate storage of food items therein as will be understood by those skilled in the art. In particular, the storage components include bins 126, drawers 128, and shelves 130 that are mounted within fresh food chamber 118. Bins 126, drawers 128, and shelves 130 are configured for receipt of food items (e.g., beverages and/or solid food items) and may assist with organizing such food items. As an example, drawers 128 can receive fresh food items (e.g., vegetables, fruits, and/or cheeses) and increase the useful life of such fresh food items.

As also may be seen in FIG. 2, refrigerator doors 122 include outer panels 132 and inner liners 134. Each refrigerator door of refrigerator doors 122 includes a respective one of outer panels 132 and inner liners 134 mounted to each other. Insulation, such as sprayed polyurethane foam, may be disposed between outer panels 132 and inner liners 134 within refrigerator doors 122 in order to assist with insulating fresh food chamber 118 when refrigerator doors 122 are in the closed position. Outer panels 132 and inner liners 134 may be constructed of or with any suitable materials. For example, outer panels 132 may be constructed of or with a metal, such a stainless steel or painted steel, and inner liners 134 may be constructed of or with a suitable plastic material. Freezer door 124 may be constructed in a similar manner as refrigerator doors 122.

Although not depicted, refrigerator appliance 100 further includes a sealed system for cooling air and a delivery system for delivering such cold air to fresh food chamber 118 and freezer chamber 120. In certain embodiments, the sealed system may include a condenser, an expansion device, evaporator, and a compressor. Such a sealed system may manipulate a refrigerant such that the refrigerant passing through the evaporator defines a relatively low temperature. Moreover, as will be discussed in greater detail below, the delivery system for delivering chilled air includes a plurality of airflow delivery conduits 150 and a plurality of orifices 166 defined in liner 116 and a fan 152. The fan 152 may be configured to generate or otherwise provide a flow of air over the evaporator (generating a flow of chilled air) and through the plurality of airflow delivery conduits 150 and orifices 166 to provide such chilled air to the chilled chamber, i.e., fresh food chamber 118 or freezer chamber 120.

Referring now to FIG. 3, a schematic view of liner 116 of exemplary refrigerator appliance 100 of FIGS. 1 and 2 is provided. As shown, liner 116 includes a plurality of walls defining the chilled chambers. More particularly, liner 116 generally includes a rear wall 154, a first side wall 156, a second and opposite side wall 158 along the lateral direction L, a top wall 160, and a bottom wall 162. Rear wall 154, first and second side walls 156, 158, and top and bottom walls 162, 164 together at least partially define fresh food chamber 118. Liner 116 additionally includes a similar configuration of walls defining freezer chamber 120.

Additionally, as previously stated, liner 116 includes a delivery system for delivering chilled air from the sealed system (not shown) to the chilled chambers defined by liner 116. More particularly, liner 116 defines an inlet 164 for receiving chilled air from the sealed system. For the embodiment depicted, inlet 164 is defined in rear wall 154 of liner 116. Additionally, refrigerator appliance 100 includes a fan 152 configured to provide a flow of air over, e.g., an evaporator of the sealed system and into inlet 164 defined by liner 116.

From inlet 164, chilled air flows through a plurality of airflow delivery conduits 150 in flow communication with inlet 164 and defined by liner 116 in the walls of liner 116. Notably, for the exemplary embodiment depicted, one or more outside layers of liner 116 are removed to expose the plurality of airflow delivery conduits 150. Liner 116 further defines a plurality of orifices 166 in the walls of liner 116 connecting the plurality of airflow delivery conduits 150 to fresh food chamber 118 (see also FIG. 2). With such a configuration, chilled air from the sealed system may be distributed throughout fresh food chamber 118 through the plurality of airflow delivery conduits 150 and orifices 166. For the embodiment depicted, the plurality of airflow delivery conduits 150 and orifices 166 are defined in rear wall 154, first and second side walls 156, 158, and top wall 160. Moreover, as depicted schematically in FIG. 3, rear wall 154, first and second side walls 156, 158, and top wall 160 each define a density of orifices 166. As used herein, “density of orifices” refers to an amount of orifices 166 defined in a particular wall of line 116 divided by an interior surface area of such wall of liner 116 (i.e., a surface area of the wall of liner 116 facing the chilled chamber). For the embodiment depicted, rear wall 154, first and second side walls 156, 158, and top wall 160 each define a density of orifices 166 of at least one orifice 166 per square foot.

It should be appreciated, however, that in other exemplary embodiments, one or more of rear wall 154, first and second side walls 156, 158, and top wall 160 may define any other suitable density of orifices 166. For example, in other embodiments, one or more of rear wall 154, first and second side walls 156, 158, and top wall 160 may define a density of orifices 166 of at least three orifices 166 per square foot, of at least five orifices 166 per square foot, of at least seven orifices 166 per square foot, or of at least ten orifices 166 per square foot. Additionally, or alternatively, in still other exemplary embodiments, the plurality of orifices 166 may not be defined in one or more of rear wall 154, first side wall 156, second side wall 158, and top wall 160. Further, in yet another exemplary embodiment, one or more of the plurality of orifices 166 may additionally or alternatively be defined in bottom wall 162.

Referring still to exemplary embodiment of FIG. 3, the plurality of airflow delivery conduits 150 include a primary delivery conduit 168 and a plurality of secondary delivery conduits 170 branching from the primary delivery conduit 168. The primary delivery conduit 168 defines a larger cross-sectional area than a cross-sectional area of any of the secondary delivery conduits 170, and at least certain of the secondary delivery conduits 170 vary in size. In general, for the exemplary embodiment depicted, the primary delivery conduit 168 and plurality of secondary delivery conduits 170 are sized to allow approximately an even amount of airflow to each of the plurality of orifices 166. It should be appreciated, that as used herein, terms of approximation, such as “approximately,” refer to being within a ten percent margin of error. Alternatively, however, primary delivery conduit 168 and plurality of secondary delivery conduits 170 may be sized such that more airflow is provided to, e.g. orifices 166 defined in rear wall 154 as compared to orifices 166 defined in first side wall 156, second side wall 158, or top wall 160.

Referring still to the embodiment depicted in FIG. 3, each of the plurality of orifices 166 are depicted defining a consistent cross-sectional size. For example, each of the plurality of orifices 166 define a cross-sectional area of less than or equal to about three quarters of a square inch (0.75 in²). Alternatively, however, in other embodiments, each of the plurality of orifices 166 may define a cross-sectional area of less than or equal to about one half of a square inch (0.5 in²), of less than or equal to about one quarter of a square inch (0.25 in²), or of less than or equal to about one eighth of a square inch (0.125 in²). By contrast, however, in still other exemplary embodiments, a cross-sectional size of each of the plurality of orifices 166 may be varied. For example, in certain exemplary embodiments, the pattern of airflow provided via the plurality of airflow delivery conduits 150 may be varied by appropriately varying a size of each of the plurality of orifices 166. For example, in certain exemplary embodiments, a cross-sectional size of each orifice 166 may generally increase with a distance from inlet 164.

It should be appreciated, that although liner 116 depicted in FIG. 3 only defines airflow delivery conduits 150 and orifices 166 in walls defining fresh food chamber 118, in other exemplary embodiments, liner 116 may additionally or alternatively define similar airflow delivery conduits 150 and orifices 166 in freezer chamber 120.

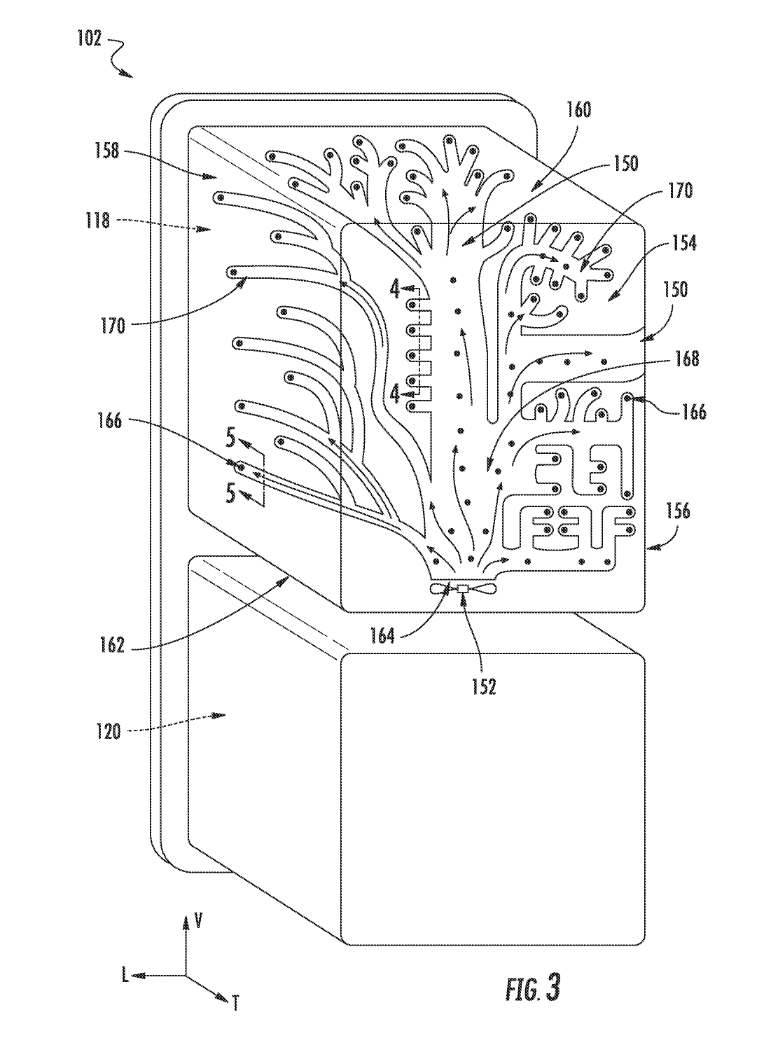

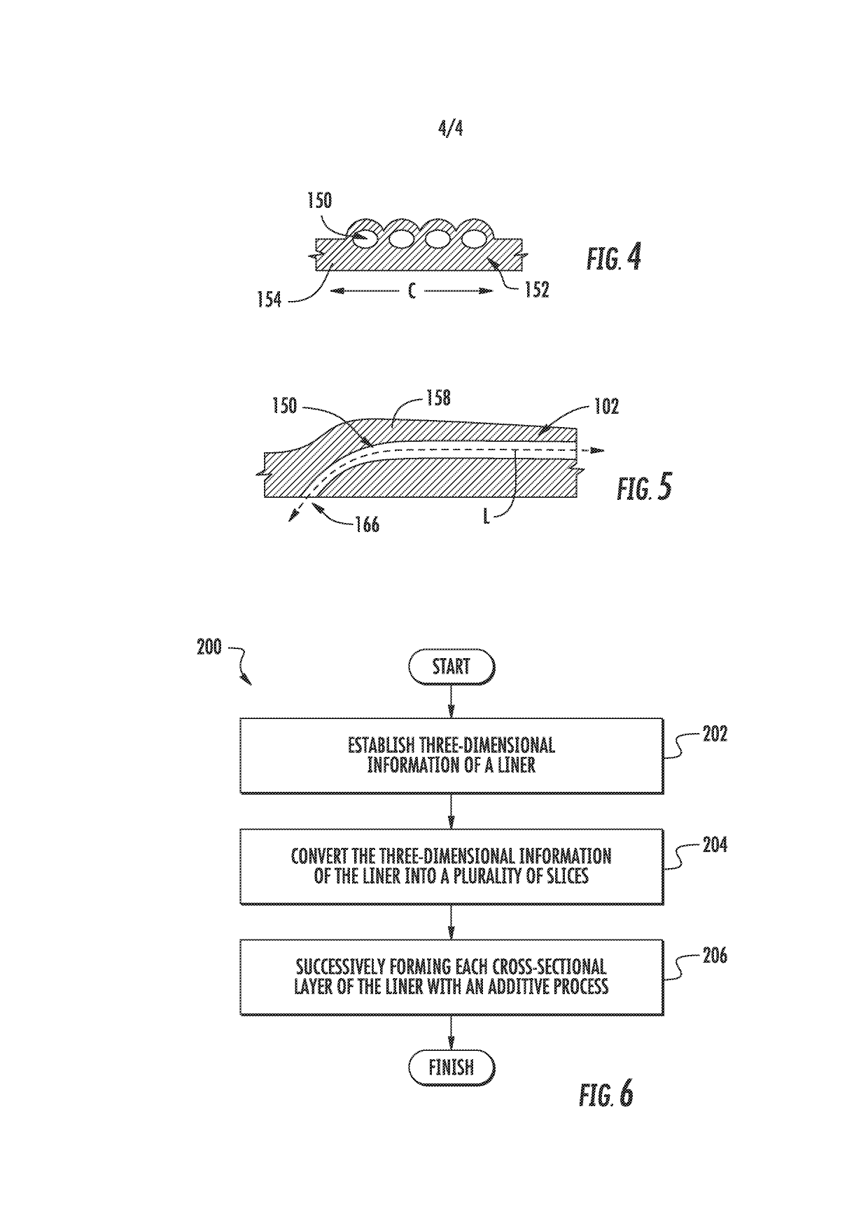

Referring now to FIGS. 4 and 5, cross-sectional views of the airflow delivery conduits 150 are provided. More particularly, FIG. 4 provides a cross-sectional view of four airflow delivery conduits 150 taken along Line 4-4 in FIG. 3; and FIG. 5 provides a cross-sectional view of an exemplary airflow delivery conduit 150 taken along Line 5-5 in FIG. 3. As shown, each of the plurality of airflow delivery conduits 150 may generally define a longitudinal direction L (FIG. 5) extending along a length of the respective airflow delivery conduit 150 (i.e., along an airflow path of the respective airflow delivery conduit 150) and a cross direction C (FIG. 4) perpendicular to the longitudinal direction L. For the exemplary embodiment depicted, the airflow delivery conduits 150 each define an elliptical cross-sectional shape in the cross direction C (FIG. 4). Moreover, as is shown in FIGS. 4 and 5, liner 116 is formed integrally around the plurality of airflow delivery conduits 150 such that the airflow delivery conduits 150 are defined within the walls of liner 116. In certain exemplary embodiments, liner 116 may be formed integrally using an additive manufacturing process, described in greater detail below.

It should be appreciated, however, that in other exemplary embodiments, the liner 116 may be formed using any other suitable method. For example, in certain exemplary embodiments, the liner may be formed as a base portion and a separate ductwork portion. The base portion may include the plurality of walls defining the chilled chambers, with the plurality or orifices extending through the walls. Additionally, the ductwork portion may be formed of a plurality of airflow delivery ducts having a shape that complements an outside of the base portion of the liner. More particularly, the ductwork portion may be configured to wrap around and attach to the plurality of walls of the base portion of the liner. The ductwork portion may thus deliver chilled air through the plurality of airflow delivery ducts, through the orifices in the walls of the base portion, and to the chilled chambers. For example, the airflow delivery ducts of the ductwork portion may be glued to the walls of the base portion or may snap into place (e.g., each airflow delivery duct may have an opening that extends into a respective orifice in a wall of the base portion). The ductwork portion may be formed using an additive manufacturing process, or alternatively may be formed by molding.

Referring now to FIG. 6, a method 200 is illustrated for forming a liner for a refrigerator appliance according to an exemplary embodiment of the present subject matter. Method 200 may be used to form any suitable liner. For example, method 200 may be used to form liner 116 described above with reference to FIGS. 1 through 5. Method 200 permits formation of various features of liner, as discussed in greater detail below. Thus, method 200 is discussed in greater detail below with reference to liner 116 of the exemplary refrigerator appliance 100 of FIGS. 1 and 2.

Method 200 includes fabricating liner 116 as a unitary liner, e.g., such that liner 116 is integrally formed of a single continuous piece of plastic, metal or other suitable material. More particularly, method 200 includes manufacturing or forming liner 116 using an additive process, such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering and other known processes. An additive process fabricates plastic or metal components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at step 202, three-dimensional information of liner 116 is determined. As an example, a model or prototype of liner 116 may be scanned to determine the three-dimensional information of liner 116 at step 202. As another example, a model of liner 116 may be constructed using a suitable CAD program to determine the three-dimensional information of liner 116 at step 202. At step 204, the three-dimensional information is converted into a plurality of slices that each defines a cross-sectional layer of liner 116. As an example, the three-dimensional information from step 202 may be divided into a plurality of equal sections or segments. Thus, the three-dimensional information from step 202 may be discretized at step 204, e.g., in order to provide planar cross-sectional layers of liner 116.

After step 204, liner 116 is fabricated using the additive process, or more specifically each layer is successively formed at step 206, e.g., by applying heat to melt and fuse a thermoplastic or by polymerizing a resin using laser energy. The layers may have any suitable size. For example, each layer may have a size between about five ten-thousandths of an inch and about one thousandths of an inch. Liner 116 may be fabricated using any suitable additive manufacturing machine as step 206. For example, any suitable laser sintering machine, inkjet printer or laser-jet printer may be used at step 206.

Utilizing method 200, liner 116 may have fewer components and/or joints than known liners. Specifically, liner 116 may require fewer components because liner 116 may be a single piece of continuous plastic or metal, e.g., rather than multiple pieces of plastic or metal joined or connected together. In addition, method 200 may permit formation of a liner 116 in accordance with an exemplary embodiment of the present disclosure including a plurality of airflow delivery conduits 150 and a plurality of orifices 166. As a result, liner 116 may provide the desired chilled air delivery benefits described above with reference to FIGS. 1 through 5.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A refrigerator appliance, comprising:
a sealed system for cooling air; and
a cabinet including a liner having a plurality of walls, the plurality of walls defining a chilled chamber, the liner defining
an inlet for receiving chilled air from the sealed system;
a plurality of airflow delivery conduits in flow communication with the inlet and extending through or adjacent to one or more of the plurality of walls; and
a plurality of orifices defined in one or more of the plurality of walls connecting the plurality of airflow delivery conduits to the chilled chamber such that chilled air from the sealed system is distributed throughout the chilled chamber through the plurality of airflow delivery conduits.

2. The refrigerator appliance of claim 1, wherein the sealed system includes an evaporator, and wherein the refrigerator appliance further includes a fan configured to provide a flow of air over the evaporator and into the inlet defined by the liner.

3. The refrigerator appliance of claim 1, wherein the plurality of airflow delivery conduits include a primary delivery conduit and a plurality of secondary delivery conduits branching from the primary delivery conduit.

4. The refrigerator appliance of claim 3, wherein the primary delivery conduit defines a larger cross-sectional area than a cross-sectional area of any of the secondary delivery conduits.

5. The refrigerator appliance of claim 1, wherein the plurality of walls of the liner the liner include a rear wall, a first side wall, and a second and opposite side wall, and wherein the plurality of airflow delivery conduits are defined in the rear wall, the first side wall, and the second side wall.

6. The refrigerator appliance of claim 5, wherein the plurality of walls of the liner further include a top wall, and wherein the plurality of airflow delivery conduits are also defined in the top wall.

7. The refrigerator appliance of claim 1, wherein the plurality of walls of the liner include a rear wall, a first side wall, and a second side wall, and wherein the rear wall, the first side wall, and the second side wall each define a density of orifices of at least three orifices per square foot.

8. The refrigerator appliance of claim 7, wherein the rear wall, the first side wall, and the second side wall each define a density of orifices of at least seven orifices per square foot.

9. The refrigerator appliance of claim 7, wherein the plurality of walls of the liner further include a top wall, and wherein the top wall defines a density of orifices of at least three orifice per square foot.

10. The refrigerator appliance of claim 9, wherein the top wall defines a density of orifices of at least seven orifice per square foot.

11. The refrigerator appliance of claim 1, wherein the plurality of airflow delivery conduits define an elliptical cross-sectional shape.

12. A method for forming a liner for a refrigerator appliance, comprising:
determining three-dimensional information of the liner;
converting the determined three-dimensional information of the liner into a plurality of slices, each slice of the plurality of slices defining a respective cross-sectional layer of the liner; and
successively forming each cross-sectional layer of the liner with an additive process;
wherein, after successively forming each cross-sectional layer of the liner with an additive process: (1) the liner includes a plurality of walls defining a chilled chamber; (2) the liner defines an inlet for receiving chilled air from a sealed system; (3) the liner further defines a plurality of airflow delivery conduits in flow communication with the inlet; and (4) the liner further defines a plurality of orifices connecting the plurality of airflow delivery conduits to the chilled chamber.

13. The method of claim 12, wherein the additive process comprises at least one of fused deposition modeling, selective laser sintering, stereolithography, and digital light processing.

14. The method of claim 12, wherein the sealed cooling system includes an evaporator, and wherein the refrigerator appliance further includes a fan configured to provide a flow of air over the evaporator and into the inlet defined by the liner.

15. The method of claim 12, wherein the plurality of airflow delivery conduits includes a primary delivery conduit and a plurality of secondary delivery conduits branching from the primary delivery conduit.

16. The method of claim 15, wherein the primary delivery conduit defines a larger cross-sectional area than a cross-sectional area of any of the secondary delivery conduits.

17. The method of claim 12, wherein the plurality of walls of the liner include a rear wall, a first side wall, and a second side wall, and wherein the plurality of airflow delivery conduits are defined in the rear wall, the first side wall, and the second side wall.

18. The method of claim 17, wherein the plurality of walls of the liner further include a top wall, and wherein the plurality of airflow delivery conduits are also defined in the top wall.

19. The method of claim 12, wherein the liner includes a rear wall, a first side wall, and a second side wall, and wherein the rear wall, the first side wall, and the second side wall each define a density of orifices of at least three orifices per square foot.

20. The method of claim 19, wherein the plurality of walls of the liner further include a top wall, and wherein the top wall defines a density of orifices of at least three orifices per square foot.
